(19) United States
(12) Patent Application Publication
(10) Pub. No.: US 2026/0042436 A1
(43) Pub. Date: Feb. 12, 2026

(54) SYSTEMS AND METHODS OF VEHICLE OPERATION TO MITIGATE ALTERATION TO DEFORMABLE SURFACES

(71) Applicant: Ford Global Technologies, LLC, Dearborn, MI (US)

(72) Inventors: Brendan Diamond, Naples, FL (US); Keith Weston, Canton, MI (US); Anthony Maraldo, Southgate, MI (US); Victor Martinez, Novi, MI (US); Michael Alan Mcnees, Flat Rock, MI (US)

(73) Assignee: Ford Global Technologies, LLC, Dearborn, MI (US)

(21) Appl. No.: 18/797,354

(22) Filed: Aug. 7, 2024

(51) Int. Cl. B60W 10/12; B60W 30/18; B60W 40/06; G06V 20/56

(52) U.S. Cl. CPC B60W 10/12; B60W 30/18172; B60W 40/06; G06V 20/588; B60W 2520/10; B60W 2552/40; B60W 2720/28; B60W 2720/30; B60W 2720/40

(57) ABSTRACT

A vehicle that can mitigate alteration caused to deformable surfaces is provided. The vehicle can capture images of the road surface in real-time and determine whether any of its wheels is currently on a deformable surface. In the instance that at least one of the wheels of the vehicle is on a deformable surface, the vehicle determines the deformity level of the deformable surface based on the captured images and based on that data and determines an amount of torque biasing to be applied to one or more wheels that are not on the deformable surface. This reduces or prevents excessive spinning of the wheel that is on the deformable surface while providing more torque to the wheel(s) that have better traction. This helps to preserve the deformable surface and allow the vehicle to traverse the deformable surface and limiting alteration to the deformable surface.

### FIELD

The present disclosure relates to the field of vehicle control on multiple types of surfaces. More specifically, embodiments of the present disclosure relate to systems and methods to control vehicle operation in order to avoid or minimize alteration to deformable surfaces.

### BACKGROUND

Vehicles use differentials (such as open differentials, limited-slip differentials, or electronic torque vectoring) to distribute torque between wheels. These systems ensure that power is transmitted effectively. During acceleration or braking, weight shifts between the front and rear axles. Torque distribution accounts for this weight transfer. Modern vehicles often have stability control systems that adjust torque distribution based on factors like wheel slip, yaw rate, and lateral acceleration.

Deformable surfaces such as grass, mud, or sand can affect traction. Tires sink into these surfaces, altering their contact area and grip. On deformable surfaces, tires experience both normal and shear forces. Normal forces compress the tire into the ground, while shear forces resist sliding. Lateral forces may affect the vehicle operation during cornering while longitudinal forces may affect the vehicle operation during acceleration, deceleration, and braking. Operation of a vehicle on a deformable surface can result in alteration of the deformable surface.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1A illustrates an environment in which the embodiments of the present disclosure may be implemented.

FIG. 1B illustrates an alteration caused to a deformable surface by a vehicle according to an embodiment of the present disclosure.

FIG. 2 illustrates a block diagram of the vehicle according to an embodiment of the present disclosure.

FIG. 3 illustrates a flow chart of a process according to an embodiment of the present disclosure.

FIG. 4 illustrates a flow chart of a process according to another embodiment of the present disclosure.

FIG. 5 illustrates a flow chart of a process according to yet another embodiment of the present disclosure.

FIG. 6 is a functional block diagram of a server according to an embodiment of the present disclosure.

### DETAILED DESCRIPTION

### Overview

The present disclosure describes systems and methods for mitigating alteration of deformable surfaces, such as mud, grass, dirt, etc., that may be caused by operation of a vehicle over these surfaces.

Embodiments of the present disclosure provide a vehicle that can operate in a manner so as to avoid or minimize alteration to a deformable surface. The vehicle may include one or more processors, a plurality of wheels and one or more sensors that are coupled to the one or more processors. The vehicle may further include a wheel location detection unit that is coupled to the one or more processors, a surface deformation estimation unit that is coupled to the one or more processors, and a wheel control unit that is coupled to the plurality of wheels. In operation, the vehicle may receive data from the one or more sensors. Based on the received data, the vehicle may cause the wheel location detection unit to determine that at least a first wheel of the plurality of wheels is currently on a deformable surface. The wheel location detection unit of the vehicle may determine that at least a second wheel of the plurality of wheels is currently on a non-deformable surface. Based on that determination, the surface deformation estimation unit of the vehicle may further determine a deformity level of the deformable surface. Based on the deformity level, the wheel control unit of the vehicle may determine an amount of torque bias to be applied to the second wheel based and the wheel control unit may apply the amount of torque bias to the second wheel.

In another instance, a method for operating a vehicle is provided. The method includes the vehicle determining that a first wheel of the vehicle is currently on a first deformable surface and that a second wheel of the vehicle is currently on a second deformable surface. Based on this, the vehicle further determines a first estimated deformity level of the first deformable surface and a second estimated deformity level of the second deformable surface. Thereafter, the vehicle may determine a first amount of torque bias to be applied to the first wheel and a second amount of torque bias to be applied to the second wheel, based on the first estimated deformity level and the second estimated deformity level. The vehicle may then apply the first amount of torque bias to the first wheel and apply the second amount of torque bias to the second wheel.

In yet another instance, a method for mitigation alteration to a deformable surface is provided. In this method a vehicle receives data from one or more sensors of the vehicle. A wheel location detection unit of the vehicle determines that at least a first wheel of the plurality of wheels is currently on a deformable surface based on the data. Thereafter the wheel location detection unit of the vehicle also determines that at least a second wheel of the plurality of wheels is currently on a non-deformable surface. A surface deformation estimation unit of the vehicle determines a deformity level of the deformable surface. The method then includes a wheel control unit of the vehicle determining an amount of torque bias to be applied to the second wheel based on the deformity level. Thereafter the wheel control unit of the vehicle applies the amount of torque bias to the second wheel.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

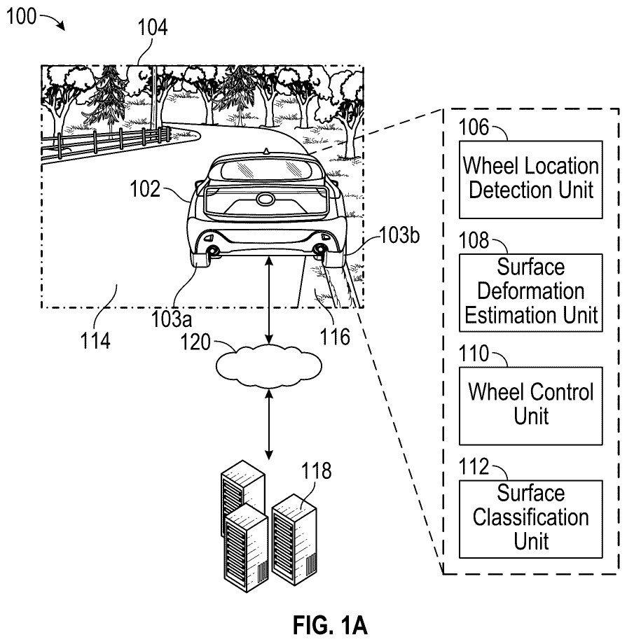

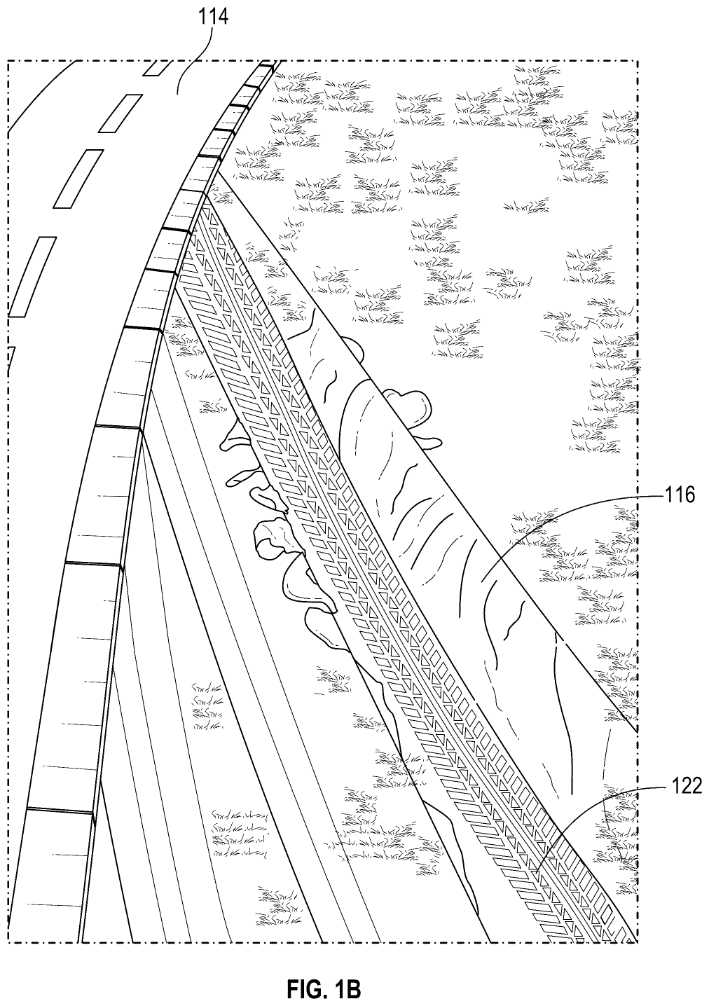

FIG. 1 illustrates an environment 100 in which the embodiments of the present disclosure may be implemented. The environment 100 may include a geographic area 104 and a vehicle 102 located in the geographic area 104. The geographic area 104 may be characterized by a paved/non-deformable surface 114 and a deformable surface 116. The paved surface 114 may include an asphalt, concrete, or any other similar surface. The deformable surface 116 may include an un-paved surface such as dirt, grass, gravel, or similar surface. In certain circumstances, the vehicle 102 may partially travel or be parked on the deformable surface 116 and partially on the paved surface 114. For example, a first wheel 103a of the vehicle 102 may be located on the paved or non-deformable surface 114 and a second wheel 103b of the vehicle 102 may be located on the deformable surface 116. When the vehicle 102 is travelling over the deformable surface 116, there is substantial possibility that the deformable surface 116 may get altered or otherwise affected by the tires of the vehicle 102 travelling over the deformable surface. FIG. 1B illustrates an instance where the deformable surface 116 is altered by the vehicle 102 travelling over the deformable surface 116. As can be seen, a tire of the vehicle has left tread marks 122 creating a dent over the deformable surface 116.

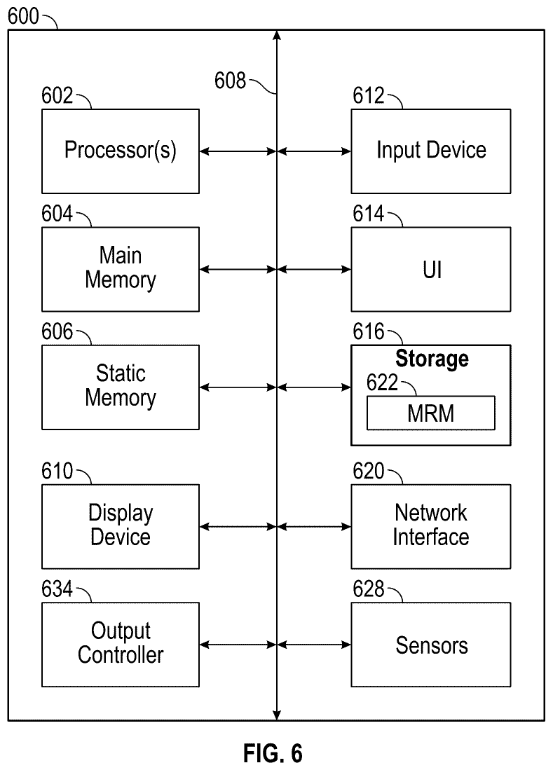

The system 100 may also include a control server 118. The control sever 118 may be part of a cloud-based computing infrastructure and may be associated with and/or include a Telematics Service Delivery Network (SDN) that provides digital data services to the vehicle 102. In additional aspects, the control server 118 may be an assistance server and may be associated with at least one of a tow assistance firm, a vehicle maintenance and repair firm, an insurance firm, and a transportation firm. Details of the control server 118 are provided below with reference to FIG. 6.

The system 100 may further include a network 120. The network 120 illustrates an example communication infrastructure in which the connected devices discussed in various embodiments of this disclosure may communicate. The network 120 may be and/or include the Internet, a private network, public network or other configuration that operates using any one or more known communication protocols such as, for example, transmission control protocol/Internet protocol (TCP/IP), Bluetooth®, Bluetooth® low Energy (BLE), Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

In an embodiment, if the vehicle 102 is travelling on the deformable surface 116, the vehicle may control a torque applied to one or more of its wheels to ensure that minimal or no alteration occurs to the deformable surface 116. In order for the vehicle to mitigate any potential alteration that may be caused to the deformable surface 116, the vehicle may have several specially programmable units that work in conjunction to detect that the vehicle is travelling on the deformable surface 116, estimate the level of deformity of the deformable surface 116, identify a type of the deformable surface 116, and adjust a torque applied to one or more of its wheels based on the estimated level of deformity and/or the type of the deformable surface 116.

In an embodiment, the vehicle 102 may include wheel location detection unit 106. The wheel location detection unit can determine location of each wheel of the vehicle 102 at any given time. For example, the wheel location detection unit 106 may determine whether any of wheels of the vehicle 102 is currently travelling on a paved surface or a deformable surface. This detection can be accomplished in several ways including, but not limited to vibration data analysis, image data analysis, etc. In an embodiment, this detection may be done in real-time as the vehicle 102 is being operated. The vehicle 102 may also include a surface deformation estimation unit 108. The surface deformation estimation unit may receive data, e.g., image and/or vibration data from the wheel location detection unit 106 and determine an estimation of the deformity level of the deformable surface 116. Once the estimated deformity level of the deformable surface is determined, that data can then be used by a wheel control unit 110 of the vehicle 102 in order to adjust the torque provided to one or more wheels of the vehicle to ensure that the wheel(s) that is currently on the deformable surface 116 does not spin or rotate excessively thereby limiting or eliminating any alteration that may be caused to the deformable surface 116. In an embodiment, the vehicle 102 may also include a road surface classification unit 112. This road surface classification unit may receive data from the wheel location detection unit 106 and/or the surface deformation estimation unit and use machine-learning algorithm(s) to classify the surface into one or more categories. In an embodiment, a certain level of deformity may be assigned to each class of the surface identified by the surface classification unit 112. The assigned level of deformity may then be used by the wheel control unit 110 to adjust the torque applied to one or more wheels of the vehicle 102. The torque biasing may be applied in context of propulsion torque or braking torque depending on whether the vehicle is gaining speed or slowing down.

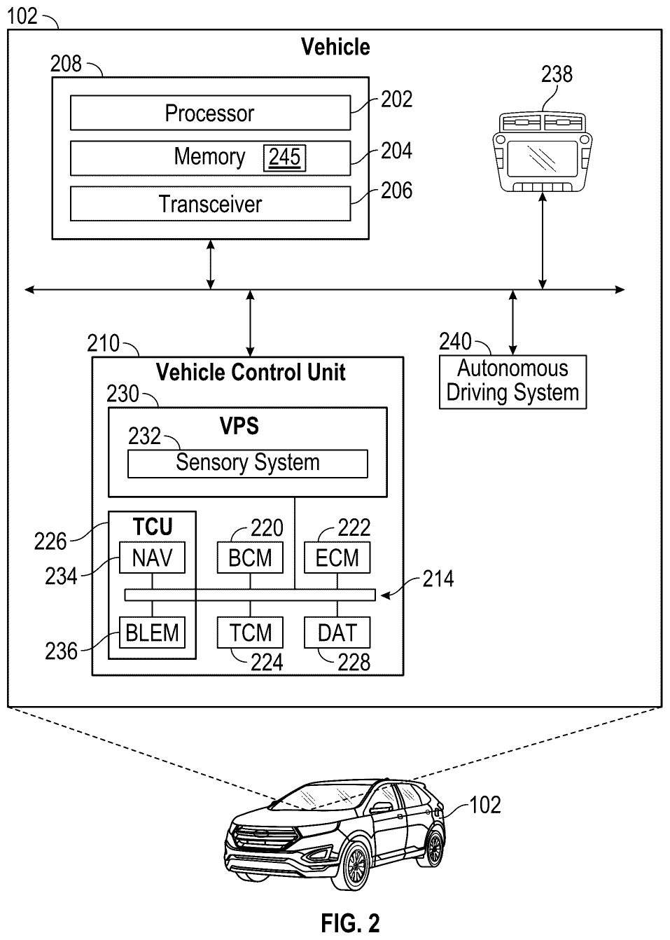

The vehicle 102 may further include a plurality of units including, but not limited to, an automotive computer, a Vehicle Control Unit (VCU), and a detection unit. Details of the vehicle 102 are provided below in reference to FIG. 2. One or more of the wheel location detection unit 106, the surface deformation estimation unit 108, the wheel control unit 110, and the road surface classification unit 112 may be implemented using one or more components described below.

FIG. 2 illustrates a block diagram of the vehicle 102 in which embodiments of the present disclosure can be implemented. The vehicle 102 may include a plurality of units including, but not limited to, an automotive computer 208, a Vehicle Control Unit (VCU) 210, and an infotainment unit 238. The VCU 210 may include a plurality of Electronic Control Units (ECUs) 214 disposed in communication with the automotive computer 208.

In some embodiments, a user device, such as a mobile phone, a laptop computer, or the like may be configured to connect with the automotive computer 208, which may communicate via one or more wireless connection(s), and/or may connect with the vehicle 102 directly by using near field communication (NFC) protocols, Bluetooth® protocols, Wi-Fi, Ultra-Wide Band (UWB), and other possible data connection and sharing techniques.

The automotive computer 208 may be installed anywhere in the vehicle 102, in accordance with the disclosure. The automotive computer 208 may be or include an electronic vehicle controller, having one or more processor(s) 202, one more memories 204, and one or more transceivers 206.

The processor(s) 202 may be disposed in communication with one or more memory devices disposed in communication with the respective computing systems (e.g., the memory 204 and/or one or more external databases not shown in FIG. 2). The processor(s) 202 may utilize the memory 204 to store programs in code and/or to store data for performing operations in accordance with the disclosure. The memory 204 may be a non-transitory computer-readable storage medium or memory storing a vehicle control program code. The memory 204 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.). In some embodiments, memory 204 may include a module 245 that can implement the various embodiments of the present disclosure. Module 245 may include instructions that can be executed by the processor 202 to realize the various embodiments of the present disclosure.

Automotive computer 208 may also include a transceiver 206. The transceiver 206 may be configured to receive information/inputs from one or more external devices or systems, e.g., a user device 208, an external server, and/or the like. Further, the transceiver 206 may transmit notifications, requests, signals, etc. to the external devices or systems. In addition, the transceiver 206 may be configured to receive information/inputs from vehicle components such as the vehicle sensory system 232, one or more ECUs 214, and/or the like. Further, the transceiver 206 may transmit signals (e.g., command signals) or notifications to the vehicle components such as the BCM 220, the infotainment system 238, and/or the like.

In some embodiments, the VCU 210 may share a power bus with the automotive computer 208 and may be configured and/or programmed to coordinate the data between vehicle systems, connected servers and/or the like. The VCU 210 may include or communicate with any combination of the ECUs 214, such as, for example, a Body Control Module (BCM) 220, an Engine Control Module (ECM) 222, a Transmission Control Module (TCM) 224, a Telematics Control Unit (TCU) 226, a Driver Assistances Technologies (DAT) controller 228, etc. The VCU 210 may further include and/or communicate with a Vehicle Perception System (VPS) 230, having connectivity with and/or control of one or more vehicle sensory system(s) 232. The vehicle sensory system 232 may include one or more vehicle sensors including, but not limited to, a Radio Detection and Ranging (RADAR or “radar”) sensor configured for detection and localization of objects inside and outside the vehicle 102 using radio waves, sitting area buckle sensors, sitting area sensors, a Light Detecting and Ranging (“LIDAR”) sensor, door sensors, proximity sensors, temperature sensors, wheel sensors, one or more ambient weather or temperature sensors, vehicle interior and exterior cameras, steering wheel sensors, etc. The sensors that are part of the vehicle sensory system 232 may be coupled to the vehicle 102 at one or more locations and in one or more manner. For example, the various sensors of the vehicle sensory system 232 may be integrated into the various subsystems of the vehicle 102, such as doors, mirrors, roof, etc. or attached to the vehicle 102 using an appropriate mounting mechanism. In some embodiments, the various sensors of the vehicle sensory system 232 may be located at the front, back, sides, top, bottom, and underneath the vehicle 102. The location of a sensor may depend on its function. For example, a sensor that monitors the area underneath the vehicle may be connected to a bottom surface of the vehicle 102 while a sensor that can monitor an area to either side of the vehicle 102 may be mounted or integrated into the doors of the vehicle 102. Vehicle sensory system 232 may also include one or more road noise sensors such as accelerometers that are coupled to various mechanical components and/or systems of the vehicle 102. One skilled in the art will realize that the sensors may be coupled to the vehicles in various different ways and locations other than the ones mentioned above.

In some embodiments, the VCU 210 may control vehicle operational aspects and implement one or more instruction sets received from the server 206, the user device 208, or from one or more instruction sets stored in the memory 204.

The TCU 226 may be configured and/or programmed to provide vehicle connectivity to wireless computing systems onboard and off board the vehicle 102, and may include a Navigation (NAV) receiver 234 for receiving and processing a GPS signal, a BLE® Module (BLEM) 236, a Wi-Fi transceiver, a UWB transceiver, and/or other wireless transceivers (not shown in FIG. 2) that may be configurable for wireless communication (including cellular communication) between the vehicle 102 and other systems (e.g., a vehicle key fob (not shown in FIG. 2), an external server, a user device, etc.), computers, and modules. The TCU 226 may be in communication with the ECUs 214 by way of a bus. In some aspects, the TCU 226 may be configured to determine a real-time vehicle geolocation, e.g., via the NAV receiver 234.

The ECUs 214 may control aspects of vehicle operation and communication using inputs from human drivers, inputs from the automotive computer 208, and/or via wireless signal inputs received via the wireless connection(s) from other connected devices, such as the server 206, among others.

The BCM 220 generally includes integration of sensors, vehicle performance indicators, and variable reactors associated with vehicle systems, and may include processor-based power distribution circuitry that may control functions associated with the vehicle body such as lights, windows, security, camera(s), audio system(s), speakers, wipers, door locks and access control, various comfort controls, etc. The BCM 220 may also operate as a gateway for bus and network interfaces to interact with remote ECUs (not shown in FIG. 2).

The DAT controller 228 may provide Level-1 through Level-3 automated driving and driver assistance functionality that may include, for example, active parking assistance, vehicle backup assistance, and/or adaptive cruise control, among other features. The DAT controller 228 may also provide aspects of user and environmental inputs usable for user authentication.

In some embodiments, the automotive computer 208 may connect with an infotainment system 238 (or a vehicle Human-Machine Interface (HMI)). The infotainment system 238 may include a touchscreen interface portion, and may include voice recognition features, biometric identification capabilities that may identify users based on facial recognition, voice recognition, fingerprint identification, or other biological identification means. In other aspects, the infotainment system 238 may be further configured to receive user instructions via the touchscreen interface portion, and/or output or display notifications, navigation maps, etc. on the touchscreen interface portion.

The computing system architecture of the automotive computer 208 and/or the VCU 210 may omit certain computing modules. It should be readily understood that the computing environment depicted in FIG. 2 is an example of a possible implementation according to the present disclosure, and thus, it should not be considered as limiting or exclusive.

In some embodiments, vehicle 102 may include an autonomous driving system 240. Vehicle 102 may be manually driven or configured to operate, using the autonomous driving system 240, in a fully autonomous (e.g., driverless) mode (e.g., Level-5 autonomy) or in one or more partial autonomous modes which may include driver assist technologies. Examples of partial autonomous (or driver assist) modes are widely understood in the art as autonomy Levels 1 through 4. For example, a vehicle having Level-1 autonomy may include a single automated driver assistance feature, such as steering or acceleration assistance. Adaptive cruise control is one such example of a Level-1 autonomous system that includes aspects of both acceleration and steering.

Level-2 autonomy in vehicles may provide driver assist technologies such as partial automation of steering and acceleration functionality, where the automated system(s) are supervised by a human driver who performs non-automated operations such as braking and other controls. In some embodiments, with Level-2 autonomous features and greater, a primary user may control the vehicle while the user is inside of the vehicle, or in some example embodiments, from a location remote from the vehicle but within a control zone extending up to several meters from the vehicle while it is in remote operation.

Level-3 autonomy in a vehicle can provide conditional automation and control of driving features. For example, Level-3 vehicle autonomy may include “environmental detection” capabilities, where the autonomous vehicle (AV) can make informed decisions independently from a present driver, such as accelerating past a slow-moving vehicle, while the present driver remains ready to retake control of the vehicle if the system is unable to execute the task.

Level-4 AVs can operate independently from a human driver, but may still include human controls for override operation. Level-4 automation may also enable a self-driving mode to intervene responsive to a predefined conditional trigger, such as a road hazard or a system event.

Level-5 AVs may include fully autonomous vehicle systems that require no human input for operation and may not include human operational driving controls.

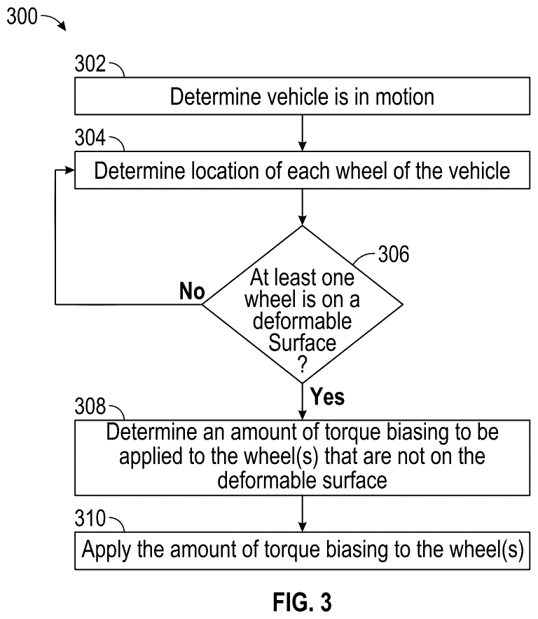

FIG. 3 illustrates a flow chart of a process 300 according to an embodiment of the present disclosure. Process 300 may be performed, for example, by the vehicle 102 of FIG. 2. Process 300 starts at step 302 where the vehicle determines that it is in motion. This determination can be made by the vehicle using, e.g., data received via a Controller Area Network (CAN) bus and/or an Automotive Audio Bus (A2B) of the vehicle 102. Based on the determination that the vehicle is in motion, the vehicle may then determine the location of each of its wheels at step 304. For example, this determination may be done by the wheel location detection unit 106 of FIG. 1A. In an embodiment, the vehicle 102 may analyze the data from its traction control system, electronic stability control system, suspension system, tire pressure monitoring system, acoustic sensors, and/or visual sensors to determine a current location of each of its wheels. Once the vehicle determines the location of each of its wheels, the vehicle may then determine whether any of its wheels or whether at least one of its wheels is currently on a deformable surface, at step 306. The determination at step 306 may be made, for example, by analyzing one or more images of the surface captured by the vehicle sensors (such as a camera). For instance, the vehicle may continually capture multiple images of the surface that it is travelling on using one or more its sensors associated with the sensory system 232. Each of these images may be analyzed to extract one or more features of the surface such as cracks, bumps, color, texture, and spatial layout, position, and edge information. For example, to extract the texture information, techniques such as Gray-Level Co-occurrence Matrix (GLCM), Local Binary Patterns (LBP), and/or Gabor filters may be used. These extracted features may then be provided as inputs to a trained machine learning model that can then classify the surface into one of several categories/types such as dirt road, gravel road, etc. In other embodiments, in addition to the image data, the vehicle may also use location data, e.g., data obtained by the GPS sensors of the vehicle, to determine the nature of the deformable surface. For example, if the user regularly drives on a long narrow driveway of his/her house and has flower beds on both sides, the vehicle may geo-tag the location of the driveway as having a deformable surface and also geo-tag the torque bias value that is calculated for that deformable surface. Thus, the next time the vehicle is at that location, it can automatically determine that torque biasing may need to be applied due to the presence of a deformable surface.

Each of the road surface type may be associated with an estimated deformity value/level. The estimated deformity value/level may be pre-assigned based on road surface analysis done off-line and the estimated deformity value/level data may be stored in a database and loaded onto, e.g., memory 204 of the vehicle 102. In operation, once the vehicle determines the type of the deformable surface, it may determine the estimated deformity level/value from this database and use that value for further processing. If at step 306, it is determined that none of the wheels of the vehicle are currently on a deformable surface, the process 300 may return to step 304 and the vehicle continues to monitor whether any of its wheels are on a deformable surface.

If at step 306, it is determined that at least one of the wheels is currently on a deformable surface, the vehicle determines an amount of torque biasing/vectoring that is to be applied to one or more wheels that are not on the deformable surface (step 308). For example, while one of the wheels of the vehicle may be traversing a dirt road, the remaining wheels of the vehicle may be on a paved surface. In one embodiment, an amount of torque biasing/vectoring to be applied may be pre-determined for each type of deformable surface. For example, a dry grass surface may be associated with a first amount of torque biasing, a wet mud surface may be associated with a second amount of torque biasing, a gravel surface may be associated with a third amount of torque biasing, etc. In another embodiment, the amount of torque biasing to be applied may be unique to the type or model of the individual vehicle 102. For example, for the same deformable surface, a first amount of torque biasing may be applied for a 4-door sedan while a second amount of torque biasing may be applied for a 4×4 truck.

Torque biasing/vectoring in vehicles is a concept often used in the context of drivetrains, particularly in differential systems, to distribute torque between wheels. It's a component in maintaining traction and stability, especially in varying driving conditions. Many vehicles have a “fully open” differential. That means when one drive wheel loses traction, no torque is delivered to the ground, and the vehicle stops moving forward. In a clutch-type limited slip or posi-traction differential, the two wheels are joined to each other through a series of clutch discs loaded with springs. When one wheel tries to spin independent of the other, the friction between the clutch discs transmits some torque to both wheels. In a torque-biasing differential, instead of using clutches and springs and friction, a series of intricate worm gears is employed. The torque is biased back and forth between wheels based on demand by using these gears and the inertia of the assembly. Torque Bias Ratio (TBR) is a measure of the maximum amount of torque that can be transmitted to the high-traction wheel before the low-traction wheel starts to spin. Higher TBR numbers equal more aggressive traction performance.

In a vehicle, the differential allows the wheels on an axle to rotate at different speeds while still receiving torque from the engine. In normal conditions, the differential distributes torque evenly between the wheels. However, when there's a difference in traction between the wheels (e.g., one wheel on ice or mud), the wheel with less traction can spin freely, while the wheel with more traction receives little or no torque. Torque biasing can be performed using different systems based on the vehicle design and other vehicle attributes such as whether the vehicle is a gas-engine vehicle, hybrid vehicle, or an electric vehicle (EV). Torque biasing differentials (TBDs) are designed to sense the difference in rotational speed between the wheels and redirect torque to the wheel with more grip. This is usually achieved through a mechanical or hydraulic mechanism inside the differential. A Mechanical Limited-Slip Differential (LSD) uses gears or clutch packs to limit the speed difference between the wheels, Electronic LSD uses electronic sensors and actuators to control torque distribution, and Active Torque Vectoring includes varying torque distribution actively based on real-time conditions, often using sensors and computer-controlled actuators.

At step 310, the determined amount of torque bias is applied to one or more wheels that are not on the deformable surface. The method of applying the torque biasing/vectoring may depend on the design of the vehicle. In one embodiment, an axle-to-axle torque vectoring may be employed. In this technique, in addition to the surface conditions, the vehicle may monitor various parameters such as wheel speeds, steering angle, throttle position, and yaw rate using one or more sensors and may vary the amount of torque sent to the front and rear axles. In this embodiment, the vehicle transfers more torque to the axle of the one or more wheels that are on the paved surfaces (i.e. axle with better traction). In another embodiment, a side-to-side torque vectoring may be employed at step 310. In the side-to-side torque vectoring, the vehicle actively distributes torque across the wheels on the same axle of the vehicle. Side-to-side torque vectoring systems can vary in their implementation. Some vehicles use brake-based torque vectoring, where individual wheel braking is used to control torque distribution between the wheels on the same axle. Other vehicles may employ more advanced differential systems (like electronic limited-slip differentials or active differentials) that can vary torque distribution mechanically or electronically between the wheels.

In some embodiments, for vehicles that are equipped with rear-steer and if the un-driven wheel(s) is on the deformable surface, the torque biasing/vectoring may be applied such that the un-driven wheel(s) does not spin excessively, so as to limit the amount of alteration caused to the deformable surface. In other embodiments where a vehicle is equipped with a fully adaptive suspension system, an un-driven wheel of the vehicle may be raised above the ground to minimize alteration to the deformable surface provided that the un-driven wheel is not supporting the weight of the engine of the vehicle. In vehicles with a dual valve suspension, if the deformable surface is lower than the paved surface, a valve on the damper of the un-driven wheel is placed in the rebound state to stiffen the suspension. If the deformable surface is higher than the paved surface, another valve on the damper of the un-driven wheel is placed in the compression mode to soften the suspension thereby minimizing alteration to the deformable surface.

In some embodiments, the amount of torque biasing can be based on the steering wheel angle and the vehicle may limit the steering wheel angle if the vehicle determines that at least one of its wheels is on a deformable surface. By limiting the amount of steering angle of the wheel, the alteration to the deformable surface can be mitigated. In other embodiments, the torque vectoring may be based on weather conditions in the current geographic area in which the vehicle is travelling. For example, if the weather data indicates that the geographic area has experienced rain in the last few hours, the vehicle may conclude that an un-paved surface in that geographic region will likely be highly deformable and the amount of torque vectoring may be further adjusted based on this determination in addition to the determination in step 306. In some embodiments, the torque biasing feature may be activated if it is determined that the vehicle is travelling at less than a threshold speed, the braking torque request is below a threshold magnitude, or the propulsive torque request is a below a threshold. In other embodiments, the amount of torque biased away from the wheel that is on the deformable surface is up to the maximum torque differential present at that time between the wheel that is located on the paved surface and the wheel that is on the deformable surface. In some embodiments, the vehicle may just truncate or reduce the amount of torque requested by the wheel on the paved surface.

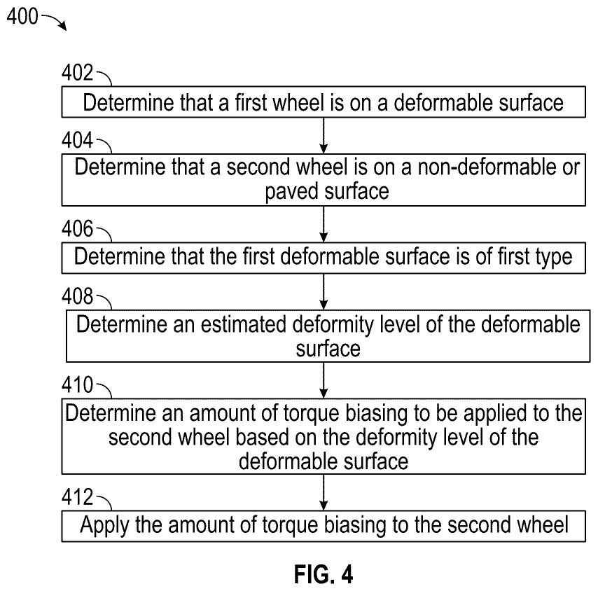

FIG. 4 illustrates a flow chart of a process 400 according to an embodiment of the present disclosure. Process 400 can be performed, for example, by the vehicle 102 of FIG. 2. At step 402, the vehicle may determine that a first wheel of the vehicle is currently on a deformable surface. This determination can be made using any of the techniques described above. At step 404, the vehicle may determine that a second wheel of the vehicle is on a non-deformable or a paved surface. At step 406, the vehicle determines a type of the deformable surface. For example, whether the deformable surface is dirt, gravel, ice, etc. Once the vehicle determines the type of the deformable surface, it may then determine an estimated deformity level of the surface at step 408. This estimation may be done, for example, by accessing a database stored in the vehicle memory. The database may include association information between a surface type and an estimated deformity level for that surface type. This database may be predetermined and included in the vehicle at the time of manufacture of the vehicle.

At step 410, the vehicle determines an amount of torque bias to be applied to the second wheel that is on the non-deformable surface. In an embodiment, the amount of torque bias can be determined using a look-up table that includes association information between an estimated deformity level of a surface and associated amount of torque biasing to be used. This look-up table may be unique to a vehicle type or the individual vehicle. In some embodiments, additional information like current vehicle speed, wheel speed of all the wheels, steering angle, the weather data, etc. may be used to further adjust the amount of torque bias. At step 412, the vehicle applies the determined amount of torque bias to the second wheel that is on the paved surface. Once the torque bias is applied to the second wheel, the vehicle adjusts the speed of the first wheel that has the torque biased away from it to match the speed of the vehicle to avoid any potential wheel slip or wheel flare. In an embodiment, the vehicle may inform a driver of the vehicle that torque biasing is being applied to one or more wheels, e.g., via the infotainment system 238 of the vehicle 102.

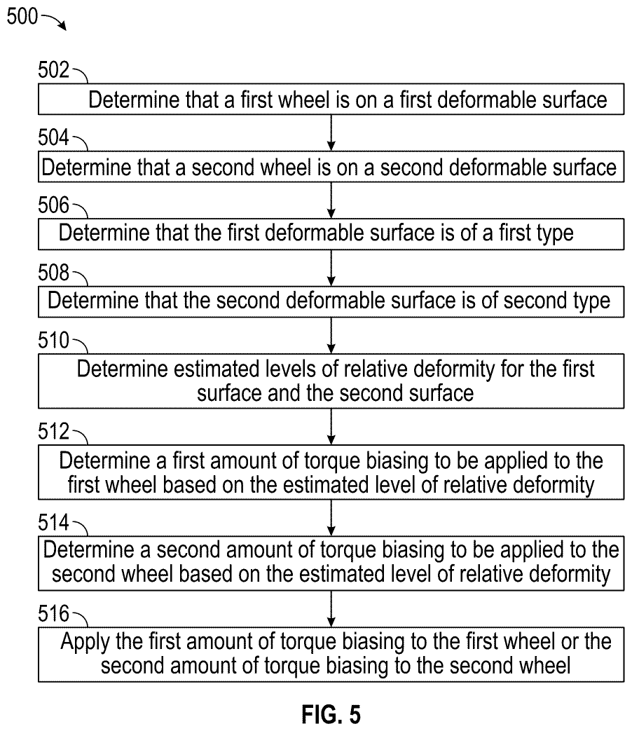

FIG. 5 illustrates a flow chart for a process 500 according to another embodiment of the present disclosure. Process 500 may be performed, for example, by the vehicle 102 of FIG. 2. At step 502, the vehicle may determine that a first wheel of the vehicle is currently on a first deformable surface such as a compacted dirt surface. At step 504, the vehicle may determine that a second wheel of the vehicle is currently on a second deformable surface, such as grass. The remaining wheels of the vehicle may be located on a non-deformable surface, such as an asphalt or concrete surface. At step 506, the vehicle may determine that the first deformable surface is of a first type, e.g., using any of the methods described above. At step 508, the vehicle may determine that the second deformable surface is of a second type. At step 512, the vehicle may determine a first estimated amount of torque biasing to be applied to the first wheel based on an estimated relative deformity level between the first deformable surface and the second deformable surface. In an embodiment, the estimated relative deformity may be determined using a ratio of the deformity level of the first deformable surface and the deformity level of the second deformable surface. In one embodiment, a deformity level of a surface may be measured using the International Roughness Index (IRI). The IRI measures the longitudinal profile of the road and calculates a numerical index that represents the roughness of the road surface over a specified length. The IRI is expressed in millimeters per meter (mm/m) or inches per mile (in/mi). In other embodiments, the deformity level of the surface may be expressed in terms of Rutting, Texture Depth, surface defects, etc.

At step 514, the vehicle may determine a second estimated amount of torque biasing to be applied to the second wheel based on the estimated level of relative deformity between the first deformable surface and the second deformable surface. Thereafter, step 516, the vehicle applies the first estimated amount of torque biasing to the first wheel and/or the second estimated amount of torque biasing to the second wheel. For example, if it is determined that the first deformable surface has a higher deformity level than the second deformable surface, then the second estimated amount of torque biasing applied to the second wheel may be higher than the first estimated amount of torque biasing applied to the first wheel to ensure that the speed of the first wheel is controlled to minimize or mitigate alteration to the first deformable surface. In this instance, the compacted dirt surface will be less deformable than the grass surface, so the torque will be biased away from the wheel that is on the grass surface and towards the wheel that is on the compacted dirt surface. In some embodiments, the torque biasing may be applied to only the wheel that is on the less deformable surface from among the two surfaces. So, the above example, the torque biasing may only be applied to the wheel that is on the compacted dirt surface.

It is to be noted that while the above-processes are described as being performed by the vehicle, in some embodiments, the vehicle may perform the above-processes in conjunction with the control server 118. For example, the control server 118 may perform the actions of receiving sensor data from the vehicle, determining the deformable surface type and the amount of torque biasing to be applied to the one or more wheels based on the sensor data and send that information to the vehicle so that the vehicle may then execute the torque biasing maneuver.

Embodiments of the present disclosure may also be used in instances where a vehicle is towing a trailer behind it. If the vehicle determines that a wheel of the trailer is on a deformable surface, the vehicle may use its sensors to determine location of the deformable surface and identify the deformation caused by the trailer wheel(s). The vehicle may then adjust the vehicle speed accordingly to minimize the alteration to the deformable surface. In the event that the vehicle determines that the trailer wheel(s) are treading on a deformable surface during a turning maneuver, the vehicle may reduce or limit the amount of turning of the vehicle-trailer combination to prevent the trailer wheels(s) from treading on the deformable surface.

FIG. 6 depicts a block diagram of an example control server 600, e.g., control server 118 of FIG. 1, upon which any of one or more techniques (e.g., methods) may be performed, in accordance with one or more example embodiments of the present disclosure. In other embodiments, the server 600 may operate as a standalone device or may be connected (e.g., networked) to other servers. In a networked deployment, the server 600 may operate in the capacity of a server machine, a client machine, or both in server-client network environments. In an example, the server 600 may act as a peer server in peer-to-peer (P2P) (or other distributed) network environments. The server 600 may be a personal computer (PC), a tablet PC, a set-top box (STB), a personal digital assistant (PDA), a mobile telephone, a smart key fob, a wearable computer device, a web appliance, a network router, a switch or bridge, or any machine capable of executing instructions (sequential or otherwise) that specify actions to be taken by that server, such as a base station. Further, while only a single server is illustrated, the term “server” shall also be taken to include any collection of servers that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific task when in operation. The configuring may occur under the direction of the execution units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The server (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The server 600 may further include a graphics display device 610, an alphanumeric input device 612 (e.g., a keyboard), and a user interface (UI) navigation device 614 (e.g., a mouse). In an example, the graphics display device 610, alphanumeric input device 612, and UI navigation device 614 may be a touch screen display. The server 600 may additionally include a storage device (i.e., drive unit) 616, a network interface device/transceiver 620 coupled to antenna(s), and one or more sensors 628, such as a global positioning system (GPS) sensor, a compass, an accelerometer, or other sensor. The server 600 may include an output controller 634, such as a serial (e.g., universal serial bus (USB)), parallel, or other wired or wireless (e.g., infrared (IR)), near field communication (NFC), etc. connection to communicate with or control one or more peripheral devices (e.g., a printer, a card reader, etc.).

The storage device 616 may include a machine readable medium 622 on which is stored one or more sets of data structures or instructions (e.g., software) embodying or utilized by any one or more of the techniques or functions described herein. The instructions may also reside, completely or at least partially, within the main memory 604, within the static memory 606, or within the hardware processor 602 during execution thereof by the server 600. In an example, one or any combination of the hardware processor 602, the main memory 604, the static memory 606, or the storage device 616 may constitute machine-readable media.

While the machine-readable medium 622 is illustrated as a single medium, the term “machine-readable medium” may include a single medium or multiple media (e.g., a centralized or distributed database, and/or associated caches and servers) configured to store the one or more instructions.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the server 600 and that cause the server 600 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions may further be transmitted or received over a communications network using a transmission medium via the network interface device/transceiver 620 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 620 may include one or more physical jacks (e.g., Ethernet, coaxial, or phone jacks) or one or more antennas to connect to the communications network. In an example, the network interface device/transceiver 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the server 600 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

It is to be noted that the vehicle implements and/or performs operations, as described here in the present disclosure, in accordance with the owner manual and safety guidelines. In addition, any action taken by the vehicle owner based on recommendations or notifications provided by the vehicle should comply with all the rules specific to the location and operation of the vehicle (e.g., Federal, state, country, city, etc.). The recommendation or notifications, as provided by the vehicle, should be treated as suggestions and only followed according to any rules specific to the location and operation of the vehicle. In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A vehicle comprising:
one or more processors;
a plurality of wheels;
one or more sensors coupled to the one or more processors;
a wheel location detection unit coupled to the one or more processors;
a surface deformation estimation unit coupled to the one or more processors; and
a wheel control unit coupled to the plurality of wheels,
wherein the one or more processors is operable to:
receive data from the one or more sensors;
cause the wheel location detection unit to determine, based on the data, that at least a first wheel of the plurality of wheels is currently on a deformable surface;
cause the wheel location detection unit to determine, based on the data, that at least a second wheel of the plurality of wheels is currently on a non-deformable surface;
cause the surface deformation estimation unit to determine a deformity level of the deformable surface;
cause the wheel control unit to determine, based on the deformity level, an amount of torque bias to be applied to the second wheel; and
cause the wheel control unit to apply the amount of torque bias to the second wheel.

2. The vehicle of claim 1, wherein the one or more sensors include one or more cameras.

3. The vehicle of claim 2, wherein to determine the deformity level of the deformable surface, the one or more processors are further operable to:
receive image data associated with the deformable surface from the one or more cameras;
cause the surface deformation estimation unit to determine, based on the image data, surface characteristics data of the deformable surface; and
cause the surface deformation estimation unit to determine the deformity level based on the surface characteristics data.

4. The vehicle of claim 3, wherein the surface characteristics data includes one or more of:
skid resistance, surface friction measurement, vibration data, or surface texture data.

5. The vehicle of claim 1, wherein the one or more processors are further operable to determine that a current vehicle speed is below a threshold speed.

6. The vehicle of claim 1, wherein the one or more processors are further operable to cause a first speed of the second wheel to match a second speed of the vehicle.

7. The vehicle of claim 1, wherein the one or more processors are further operable to cause the wheel control unit to determine the amount of torque bias based on a steering angle of the vehicle.

8. The vehicle of claim 1, wherein the one or more processors are further operable to cause the wheel control unit to determine the amount of torque bias based on weather data associated with the deformable surface.

9. A method comprising:
determining, by a vehicle, that a first wheel of the vehicle is currently on a first deformable surface;
determining, by the vehicle, that a second wheel of the vehicle is currently on a second deformable surface;
determining, by the vehicle, a first estimated deformity level of the first deformable surface;
determining, by the vehicle, a second estimated deformity level of the second deformable surface;
determining, by the vehicle, a first amount of torque bias to be applied to the first wheel based on the first estimated deformity level and the second estimated deformity level;
determining, by the vehicle, a second amount of torque bias to be applied to the second wheel based on the first estimated deformity level and the second estimated deformity level;
applying, by the vehicle, the first amount of torque bias to the first wheel; and
applying, by the vehicle, the second amount of torque bias to the second wheel.

10. The method of claim 9, wherein determining that the first wheel of the vehicle is currently on the first deformable surface further comprises:
receiving, from one or more cameras of the vehicle, image data associated with the first deformable surface;
determining, using the image data, surface characteristics of the first deformable surface; and
determining, based on the surface characteristics, that the first wheel is on the first deformable surface.

11. The method of claim 9, further comprising determining a ratio of the first estimated deformity level and the second estimated deformity level, wherein the first amount of torque bias and the second amount of torque bias are based on the ratio.

12. The method of claim 9, wherein the first estimated deformity level is higher than the second estimated deformity level and the second amount of torque bias is higher than the first amount of torque bias.

13. The method of claim 9, further comprising matching a first speed of the first wheel to a second speed of the vehicle.

14. The method of claim 9, wherein determining the first estimated deformity level of the first deformable surface further comprises determining one or more of:
a roughness index for the first deformable surface;
a surface texture of the first deformable surface; or
rutting associated with the first deformable surface.

15. A method comprising:
receiving, by a vehicle, data from one or more sensors of the vehicle;
determining, by a wheel location detection unit of the vehicle and based on the data, that at least a first wheel of a plurality of wheels is currently on a deformable surface;
determining, by the wheel location detection unit of the vehicle and based on the data, that at least a second wheel of the plurality of wheels is currently on a non-deformable surface;
determining, by a surface deformation estimation unit of the vehicle, a deformity level of the deformable surface;
determining, by a wheel control unit of the vehicle and based on the deformity level, an amount of torque bias to be applied to the second wheel; and
applying, by the wheel control unit of the vehicle, the amount of torque bias to the second wheel.

16. The method of claim 15, wherein the one or more sensors includes one or more cameras and wherein determining the deformity level of the deformable surface further comprising:
receiving, by the vehicle, image data associated with the deformable surface from the one or more cameras;
determining, by the surface deformation estimation unit and based on the image data, surface characteristics data of the deformable surface; and
determining, by the surface deformation estimation unit, the deformity level based on the surface characteristics data.

17. The method of claim 15, further comprising causing, by the vehicle, a first speed of the second wheel to match a second speed of the vehicle.

18. The method of claim 15, further comprising determining, by the wheel control unit, the amount of torque bias based on a steering angle of the vehicle.

19. The method of claim 15, further comprising determining, by the wheel control unit, the amount of torque bias based on weather data associated with the deformable surface.

20. The method of claim 15, wherein prior to determining the amount of torque bias, determining that a current vehicle speed is below a threshold speed.
